(19) United States
(12) Patent Application Publication
(10) Pub. No.: US 2017/0197651 A1
(43) Pub. Date: Jul. 13, 2017

(54) STEERING WHEEL COVER

(71) Applicant: Yuan-Yuan HUANG, Tainan City (TW)

(72) Inventor: Yuan-Yuan HUANG, Tainan City (TW)

(21) Appl. No.: 14/992,126

(22) Filed: Jan. 11, 2016

(51) Int. Cl. B62D 1/06

(52) U.S. Cl. CPC B62D 1/06

(57) ABSTRACT

A steering wheel cover includes an annular inner core having first and second flanks, a looped skin layer having first and second marginal zones, and first and second fasteners. The first marginal zone of the looped skin layer is fastened to an inner flank surface of the first flank by virtue of the first fastener. The second marginal zone of the looped skin layer is detachably fastened to an inner flank surface of the second flank by virtue of the second fastener.

### FIELD

The disclosure relates to a steering wheel cover.

### BACKGROUND

With reference to FIGS. 1 and 2, a conventional steering wheel cover normally includes an annular core layer 4 made of a rubber material, and a skin layer 5 covering the inner layer 4. The annular core layer 4 extends in a circumferential direction, and has a base 42, two flanks 41, and an annular gap 431 defined between two flank edges 411 of the two flanks 41. The base 42 and the flanks 41 define thereamong an annular space 43 for receiving a steering wheel (not shown). The steering wheel can be inserted into the annular space 43 through the annular gap 431. The skin layer 5 has two lateral marginal regions 51 which are respectively bonded to inner surfaces of the two flanks 41 by stitching. As shown in FIG. 2, to stitch the lateral marginal regions 51 respectively to the two flanks 42, it is necessary to deform the annular core layer 4. The locations to be stitched need to be correctly estimated to ensure that the skin layer 5, after stitching, is of a width capable of evenly covering the annular core layer 4 when the annular core layer 4 resumes its original shape. If the width is too short, the annular core layer 4 may be unduly compressed by the skin layer 5. If the width is too long, the skin layer 5 may move relatively to the annular core layer 4 when in use. Therefore, the process for stitching the skin layer 5 onto the annular core layer 4 is relatively complicated.

Taiwanese utility model no. 411920 (U) discloses a similar steering wheel cover which also encounters the above problem.

### SUMMARY

Therefore, an object of the disclosure is to provide a novel steering wheel cover in which a marginal zone of a looped skin layer can be detachably fastened to a flank of an annular inner core. Thus, the looped skin layer can be more easily attached to the annular inner core.

According to the disclosure, a steering wheel cover includes an annular inner core, a looped skin layer, and first and second fasteners. The annular inner core is made of a deformable material, defines a central axis, and includes a base and first and second flanks. The base extends in a circumferential direction to surround the central axis, and has two inner boundary regions opposite to each other in a direction of the central axis. Each of the first and second flanks has inner and outer flank surfaces, and extends from a corresponding one of the inner boundary regions in radial directions to terminate at a flank edge so as to permit the flank edges of the first and second flanks to be spaced apart from each other by an annular gap which is configured such that when the annular inner core is brought to wrap around the wheel rim by enlarging the annular gap, the first and second flanks are deformed to generate a biasing force against the wheel rim, thereby permitting the annular inner core to be in frictional engagement with the wheel rim. The looped skin layer is made of a flexible decorative material, and includes a base segment, first and second lateral segments, and first and second marginal zones. The base segment extends in the circumferential direction to cover the base, and has two outer boundary regions opposite to each other in the direction of the central axis. Each of the first and second lateral segments extends from a corresponding one of the outer boundary regions in the radial directions to terminate at a lateral juncture to cover a corresponding one of the first and second flanks. Each of the first and second marginal zones extends from the lateral juncture of a corresponding one of the first and second lateral segments to terminate at a connection area such that when each of the first and second marginal zones is stretched along a corresponding one of the flank edges, the connection area is brought to confront a corresponding one of the inner flank surfaces of the first and second flanks. The first fastener is configured to fasten the inner flank surface of the first flank to the connection area of the first marginal zone. The second fastener includes a loop portion and a hook portion. The loop portion is disposed on one of the inner flank surface of the second flank and the connection area of the second marginal zone. The hook portion is disposed on the other one of the inner flank surface of the second flank and the connection area of the second marginal zone so as to permit the inner flank surface of the second flank to be detachably fastened to the connection area of the second marginal zone.

### BRIEF DESCRIPTION OF THE DRAWINGS

Other features and advantages of the disclosure will become apparent in the following detailed description of the embodiments with reference to the accompanying drawings, in which:

FIG. 1 is a perspective view of a conventional steering wheel cover;

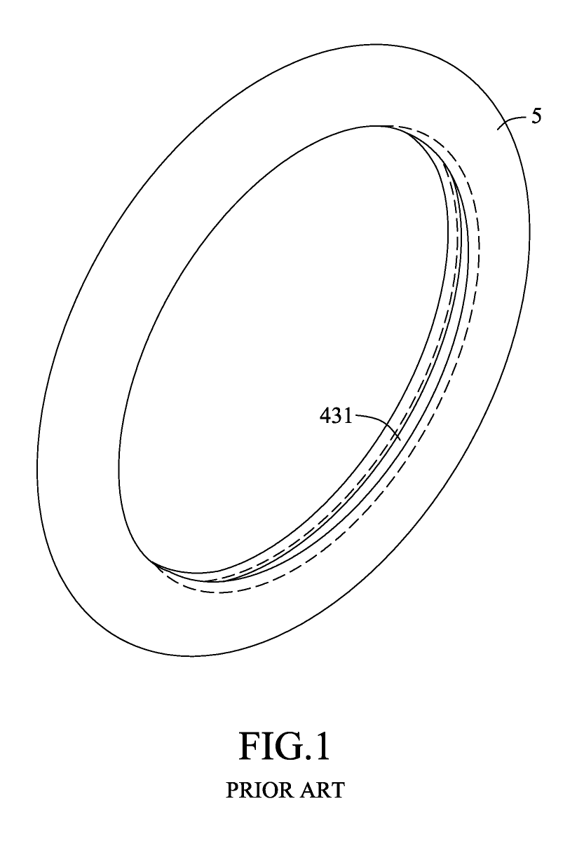

FIG. 2 is a schematic diagram illustrating a process for making the conventional steering wheel cover;

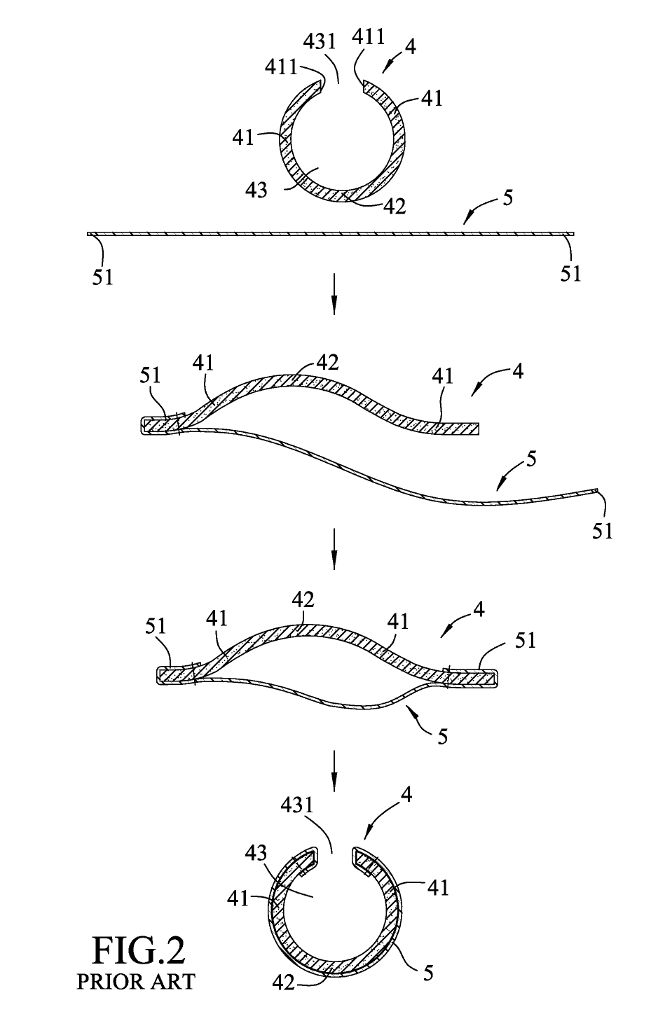

FIG. 3 is a perspective view of a steering wheel cover according to a first embodiment of the disclosure;

FIG. 4 is a perspective view of an annular inner core of the steering wheel cover of FIG. 3;

FIG. 5 is a cross-sectional view taken along line 5-5 of FIG. 3;

FIG. 6 is a cross-sectional view taken along plane A of FIG. 4;

FIG. 7 is a schematic diagram illustrating a process for making the steering wheel cover of FIG. 3;

FIG. 8 is a schematic view illustrating how a marginal zone of a looped skin layer is attached to an inner flank surface of a flank of the annular inner core; and

FIG. 9 is a cross-sectional view of a steering wheel cover according to a second embodiment of the disclosure.

### DETAILED DESCRIPTION

Before the disclosure is described in greater detail, it should be noted that like elements are denoted by the same reference numerals throughout the disclosure.

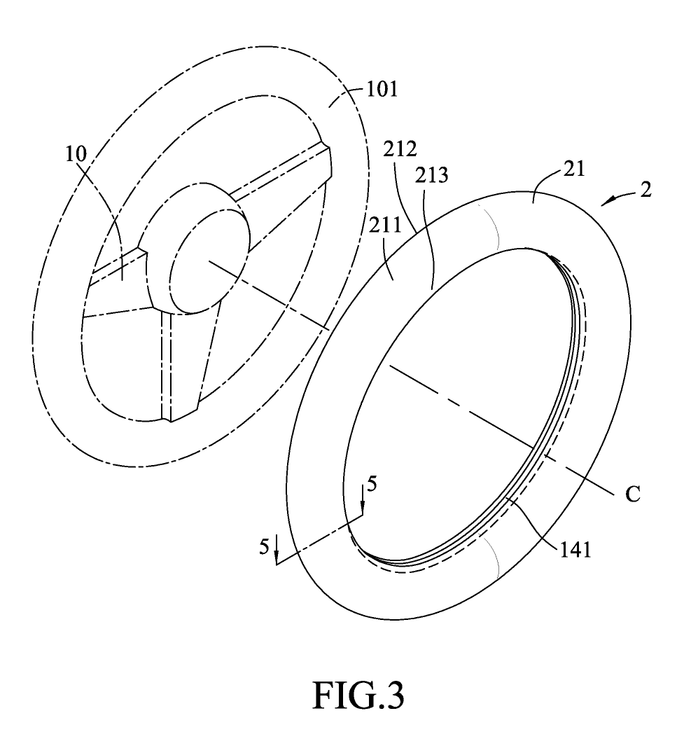

With reference to FIG. 3, a steering wheel cover according to a first embodiment of the disclosure is used for wrapping a steering wheel 10 having a wheel rim 101. As shown in FIGS. 3 to 5, the steering wheel cover includes an annular inner core 1, a looped layer unit 2, a first fastener 30, and a second fastener 3. Each of the annular inner core 1 and the looped layer unit 2 has a C-shaped cross-section.

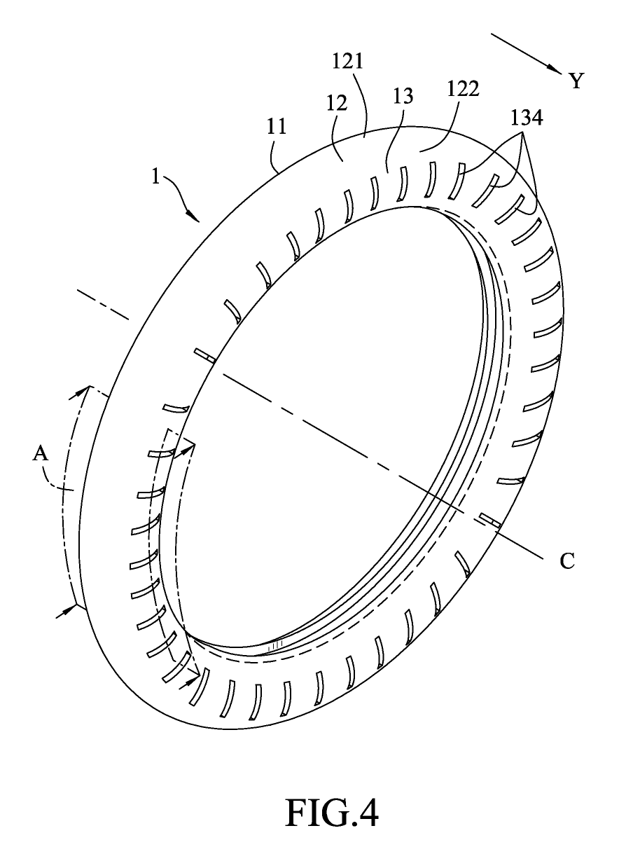

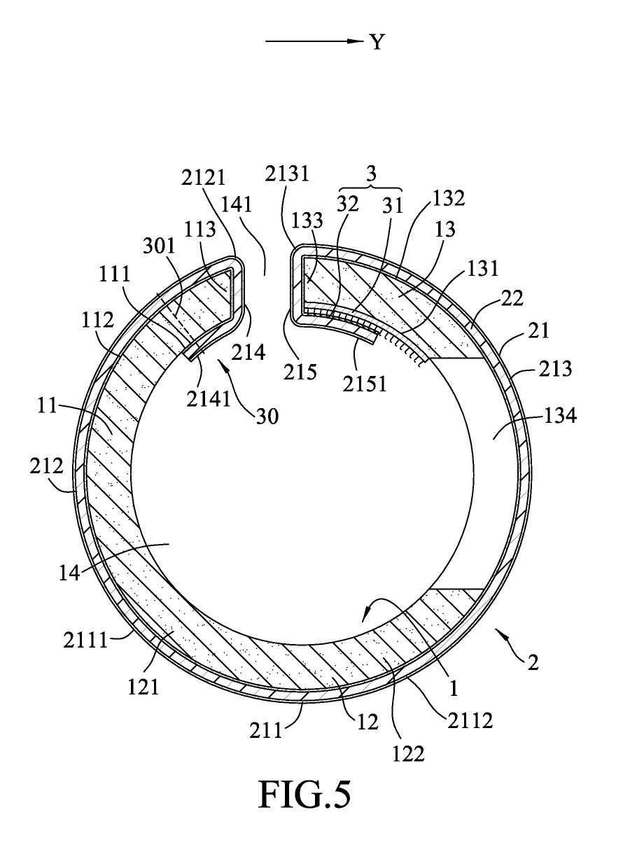

The annular inner core 1 is made of a deformable material, such as a rubber material, and defines a central axis (C). As shown in FIGS. 4 and 5, the annular inner core 1 includes a base 12 and first and second flanks 11, 13, which cooperatively define an annular space 14 thereamong for receiving the wheel rim 101.

The base 12 extends in a circumferential direction to surround the central axis (C), and has two inner boundary regions 121, 122 opposite to each other in a direction of the central axis (C) (i.e., Y direction).

The first flank 11 has inner and outer flank surfaces 111, 112 and extends from the inner boundary region 121 in radial directions to terminate at a flank edge 113. The second flank 13 has inner and outer flank surfaces 131, 132 and extends from the inner boundary region 122 in radial directions to terminate at a flank edge 133. The flank edges 113, 133 are spaced apart from each other by an annular gap 141 which is in spatial communication with the annular space 14 and which is configured such that when the annular inner core 1 is wrapped around the wheel rim 101 by enlarging the annular gap 141, the first and second flanks 11, 13 are deformed to generate a biasing force against the wheel rim 101, thereby permitting the annular inner core 1 to be in frictional engagement with the wheel rim 101.

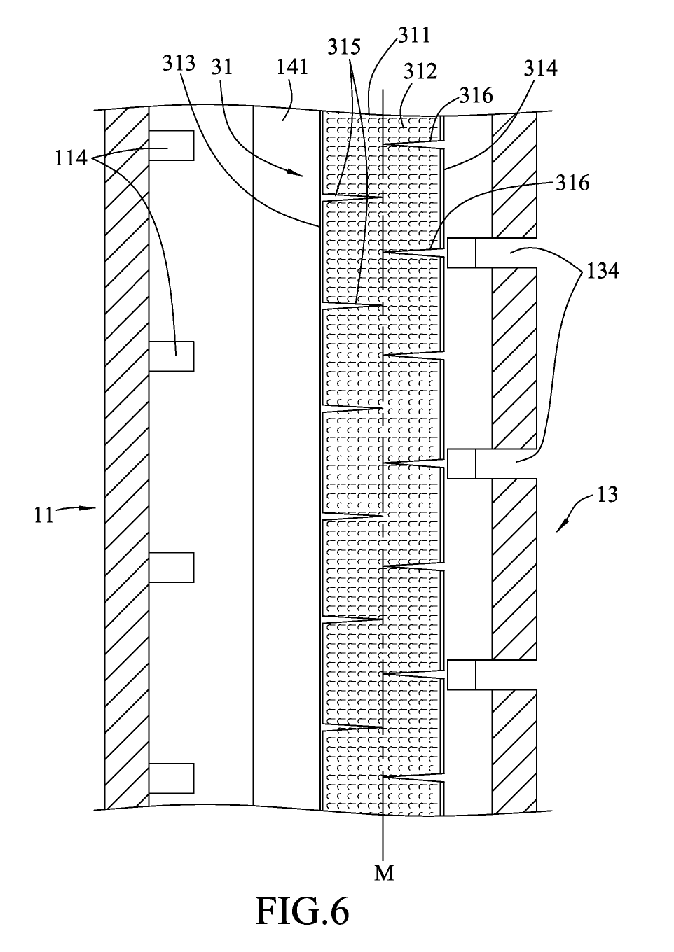

In this embodiment, the first flank 11 has a plurality of first slits 114 (see FIG. 6) each extending radially. The first slits 114 are displaced from each other in the circumferential direction. The second flank 13 has a plurality of second slits 134 (see FIGS. 4 and 6) each extending radially. The second slits 134 are displaced from each other in the circumferential direction. Each of the first slits 114 is staggered from a corresponding one of the second splits 134. With the provision of the first and second slits 114, 134, the annular inner core 1 can be easily deformed between a normal state and a bent state, and can be easily wrapped around the wheel rim 101.

In addition, because the annular inner core 1 with the first and second slits 114, 134 has better flexibility, the annular inner core 1 can match steering wheels of different dimensions.

Furthermore, the base 12 may have a plurality of slits (not shown) displaced from each other in the circumferential direction. In other embodiments, the first and second flanks 11, 13 are not formed with the slits, and only the base 12 has the slits.

The looped layer unit 2 is deformable with the annular inner core 1, and includes a looped skin layer 21 which is made of a flexible decorative material, such as natural leather, synthetic leather, and fabric, and which also provides tactile comfort. As shown in FIGS. 3 and 5, the looped skin layer 21 includes a base segment 211, first and second lateral segments 212, 213, and first and second marginal zones 214, 215.

The base segment 211 extends in the circumferential direction to cover the base 12, and has two outer boundary regions 2111, 2112 opposite to each other in the direction of the central axis (C) (Y direction).

The first lateral segment 212 extends from the outer boundary region 2111 in the radial directions to terminate at a lateral juncture 2121 to cover the first flank 11. The first marginal zone 214 extends from the lateral juncture 2121 to terminate at a connection area 2141 such that when the first marginal zone 214 is stretched along the flange edge 113 of the first flank 11, the connection area 2141 is brought to confront the inner flank surface 111 of the first flank 11.

The second lateral segment 213 extends from the outer boundary region 2112 in radial directions to terminate at a lateral juncture 2131 to cover the second flank 13. The second marginal zone 215 extends from the lateral juncture 2131 to terminate at a connection area 2151 such that when the second marginal zone 215 is stretched along the flange edge 133 of the second flank 13, the connection area 2151 is brought to confront the inner flank surface 131 of the second flank 13.

The first fastener 30 is configured to fasten the inner flank surface 111 of the first flank 11 to the connection area 2141 of the first marginal zone 214.

The second fastener 3 is a Velcro fastener and includes a hook portion 31 and a loop portion 32. The loop portion 32 is disposed on one of the inner flank surface 131 of the second flank 13 and the connection area 2151 of the second marginal zone 215, and the hook portion 31 is disposed on the other one of the inner flank surface 131 of the second flank 13 and the connection area 2151 of the second marginal zone 215 so as to permit the inner flank surface 131 of the second flank 13 to be detachably fastened to the connection area 2151 of the second marginal zone 215.

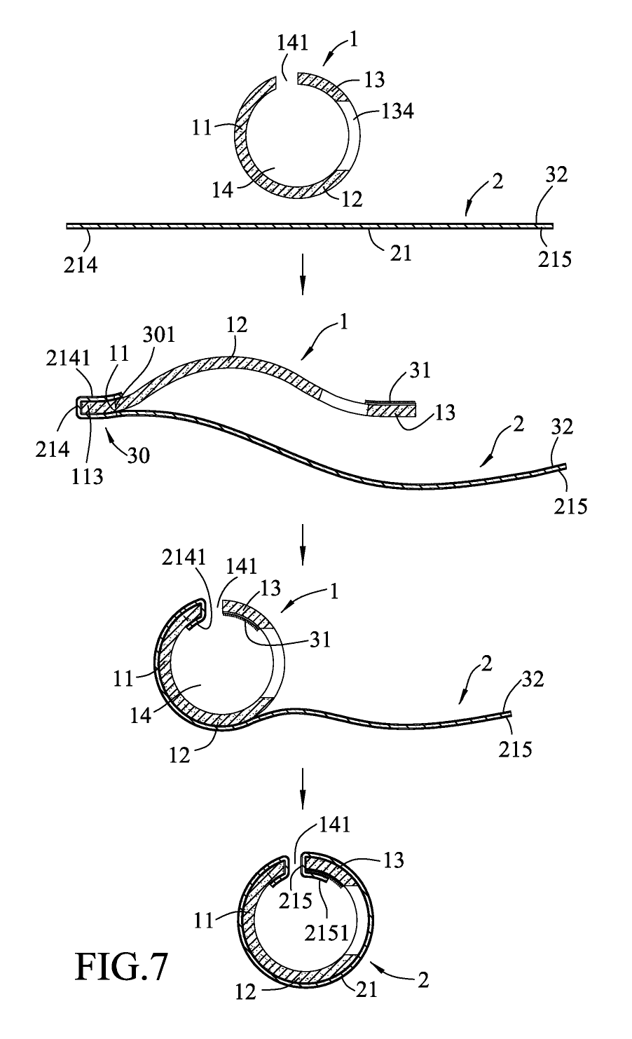

In this embodiment, the first fastener 30 is a stitched seam 301. As shown in FIG. 7, the stitched seam 310 is formed by a step of stitching the connection area 2141 of the first marginal zone 214 to the first flank 11 when the first marginal zone 214 is stretched along the flank edge 113 of the first flank 11 and when the annular inner core 1 is in the bent state. In the bent state, the first and second flanks 11, 13 are bent away from each other.

After the stitching step, the annular inner core 1 is restored to the normal state from the bent state so as to permit the connection area 2151 of the second marginal zone 215 to be brought to confront the inner flank surface 131 of the second flank 13 (see FIGS. 5 and 7).

As shown in FIG. 5, the hook portion 31 is disposed on the inner flank surface 131 of the second flank 13, and the loop portion 32 is disposed on the connection area 2151 of the second marginal zone 215.

In this embodiment, the hook portion 31 is also stitched to the inner flank surface 131 of the second flank 13 in the stitching step.

It is worth mentioning that when wrapping the wheel rim 101 of the steering wheel 10, if the first and second flanks 11, 13 are brought to respectively engage rear and front sides of the wheel rim 101 of the steering wheel 10, the stitched seam 301 is not visible when viewed from the front side of the steering wheel 10.

In this embodiment, the looped layer unit 2 further includes an inner soft layer 22 which is disposed between the annular inner core 1 and the looped skin layer 21, and which is made of a foamed material or a sponge material. With the provision of the inner soft layer 22, it is more comfortable to grip the steering wheel 10.

In this embodiment, the inner soft layer 22 has velvet lining (also denoted by 32) which serves as the loop portion 32.

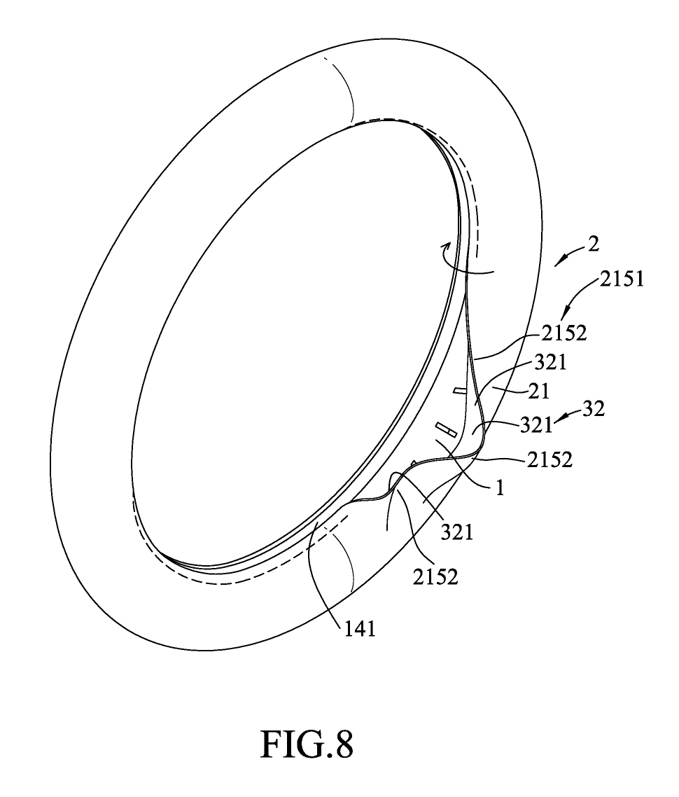

It should be noted that the first marginal zone 214 of the looped skin layer 21 is stitched to the first flank 11, and the second marginal zone 215 is stretched to permit the loop portion 32 on the connection area 2151 to be detachably fastened to the hook portion 31 on the inner flank surface 131 of the second flank 13. To be specific, as shown in FIG. 8, the connection area 2151 has a plurality of subareas 2152 displaced from one another in the circumferential direction, and the loop portion 32 has a plurality of loop regions 321 displaced from one another in the circumferential direction. The subareas 2152 are sequentially stretched to permit each of the loop regions 321 to be detachably fastened to the hook portion 31 (not shown in FIG. 8 but shown in FIG. 5). Thus, the looped layer unit 2 (the looped skin layer 21) can evenly cover the annular inner core 1 in a simple manner.

With reference to FIGS. 4 and 6, the hook portion 31 extends along a circumferential line (M) which surrounds the central axis (C), and which divides the hook portion 31 into left and right halves 311, 312. The left half 311 has a left marginal edge 313 and is interrupted by a plurality of left splits 315 each extending from the left marginal edge 313 toward the circumferential line (M). The left splits 315 are displaced from each other in the circumferential direction. The right half 312 has a right marginal edge 314 and is interrupted by a plurality of right splits 316 each extending from the right marginal edge 314 toward the circumferential line (M). The right splits 316 are displaced from each other in the circumferential direction. Each of the left splits 315 is staggered from a corresponding one of the right splits 316. Although the hook portion 31 is normally made of a material with a poorer flexibility than the material of the annular inner core 1, the hook portion 31 can be stretched due to the provision of the left and right splits 315, 316, thereby allowing the hook portion 31 to deform with the deformation of the annular inner core 1.

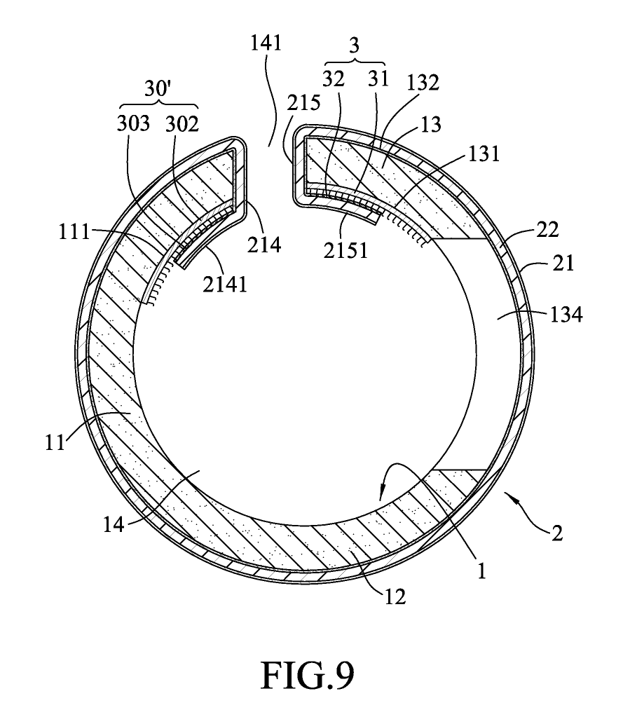

FIG. 9 is a cross-sectional view of a steering wheel cover according to a second embodiment of the disclosure. The second embodiment is similar to the first embodiment except that in the second embodiment, the first fastener 30′ is also a Velcro fastener, and includes a hook portion 302 and a loop portion 303. The hook portion 302 is disposed on the inner flank surface 111 of the first flank 11 by stitching. The loop portion 303 disposed on the connection area 2141 of the first marginal zone 214 so as to permit the inner flank surface 111 of the first flank 11 to be detachably fastened to the connection area 2141 of the first marginal zone 214. In this embodiment, the velvet lining of the inner soft layer 22 serves as both of the loop portions 303, 32.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A steering wheel cover for a steering wheel which has a wheel rim, said steering wheel cover comprising:
an annular inner core which is made of a deformable material, which defines a central axis, and which includes
a base extending in a circumferential direction to surround the central axis, and having two inner boundary regions opposite to each other in a direction of the central axis, and
first and second flanks each having inner and outer flank surfaces, and each extending from a corresponding one of said inner boundary regions in radial directions to terminate at a flank edge so as to permit said flank edges of said first and second flanks to be spaced apart from each other by an annular gap which is configured such that when said annular inner core is brought to wrap around the wheel rim by enlarging said annular gap, said first and second flanks are deformed to generate a biasing force against the wheel rim, thereby permitting said annular inner core to be in frictional engagement with the wheel rim;
a looped skin layer made of a flexible decorative material, and including
a base segment extending in the circumferential direction to cover said base, and having two outer boundary regions opposite to each other in the direction of the central axis,
first and second lateral segments each of which extends from a corresponding one of said outer boundary regions in the radial directions to terminate at a lateral juncture to cover a corresponding one of said first and second flanks, and
first and second marginal zones each of which extends from said lateral juncture of a corresponding one of said first and second lateral segments to terminate at a connection area such that when each of said first and second marginal zones is stretched along a corresponding one of said flank edges, said connection area is brought to confront a corresponding one of said inner flank surfaces of said first and second flanks;
a first fastener configured to fasten said inner flank surface of said first flank to said connection area of said first marginal zone; and
a second fastener including:
a loop portion disposed on one of said inner flank surface of said second flank and said connection area of said second marginal zone, and
a hook portion disposed on the other one of said inner flank surface of said second flank and said connection area of said second marginal zone so as to permit said inner flank surface of said second flank to be detachably fastened to said connection area of said second marginal zone.

2. The steering wheel cover according to claim 1, wherein said first fastener is a stitched seam.

3. The steering wheel cover according to claim 2, wherein said stitched seam is formed by a step of stitching said connection area of said first marginal zone to said first flank when said first marginal zone is stretched along said flank edge of said first flank and when said annular inner core is in a bent state, where said first and second flanks are bent away from each other.

4. The steering wheel cover according to claim 3, wherein after the stitching step, said annular inner core is restored to a normal state from the bent state so as to permit said connection area of said second marginal zone to be brought to confront said inner flank surface of said second flank.

5. The steering wheel cover according to claim 1, wherein said hook portion is disposed on said inner flank surface of said second flank, and said loop portion is disposed on said connection area of said second marginal zone.

6. The steering wheel cover according to claim 5, wherein said hook portion extends along a circumferential line which divides said hook portion into left and right halves, said left half having a left marginal edge and being interrupted by a plurality of left splits each extending from said left marginal edge toward said circumferential line, said left splits being displaced from each other in the circumferential direction, said right half having a right marginal edge and being interrupted by a plurality of right splits each extending from said right marginal edge toward said circumferential line, said right splits being displaced from each other in the circumferential direction, each of said left splits being staggered from a corresponding one of said right splits.

7. The steering wheel cover according to claim 1, wherein said first flank has a plurality of radially extending first slits which are displaced from each other in the circumferential direction, and said second flank has a plurality of radially extending second slits which are displaced from each other in the circumferential direction, each of said first slits being staggered from a corresponding one of said second splits.
